(19) United States
(12) Patent Application Publication
(10) Pub. No.: US 2017/0177738 A1
(43) Pub. Date: Jun. 22, 2017

(54) DYNAMIC INTENT REGISTRY

(71) Applicant: Google Inc., Mountain View, CA (US)

(72) Inventor: Kenneth J. Goldman, Palo Alto, CA (US)

(21) Appl. No.: 14/976,994

(22) Filed: Dec. 21, 2015

(51) Int. Cl. G06F 17/30

(52) U.S. Cl. CPC G06F 17/30958; G06F 17/30705

(57) ABSTRACT

Methods, systems, and apparatus, including computer programs encoded on a computer storage medium, for relating the operation of applications on a user device are described including accessing, for a first application, intent data describing intent groups for the first application, each intent group including one or more intents that belong to the intent group, determining enabling connectors for the intent groups, each enabling connector specifying an enabling intent that causes a corresponding intent group to become active in the first application, generating intent group association data that associates intent groups to other intent groups by enabling connectors, wherein an enabling intent associates a first intent group to a second intent group, and the second intent group becomes active in response to an execution of the enabling connector, and providing the intent group association data to a user device that has the first application installed.

### BACKGROUND

Speech recognition and speech processing systems are prevalent in many consumer electronic devices. Many of these electronic devices now utilize speech command processing techniques to invoke and perform particular operations. For example, a user device, such as a smart phone, can process speech commands to perform specified operations that include searching the web, setting an alarm, calling a particular person, and so on. Such speech recognitions systems also facilitate accessibility services for persons that have certain accessibility challenges.

With the advent of tablet computers and smart phones, applications that facilitate the performance of the various functions that operate on content retrieved over the Internet, or that operate on content local to a user device, are now very common. Many users thus have multiple applications on their mobile devices. Such applications include games, mapping applications, note taking applications, finance applications, and so on.

However, for a user to make use of the various functions supported by an application, the application must either be instantiated and be able to receive user input, or, alternatively, must specify to a third party application that the application is capable of processing an “intent” for the third party application. As used in this specification, an “intent” is a description of an operation in an application to be performed (an “action”), and can also specify parameter values (the data to be operated on) for processing by the specified operation. Intents can be specific to a particular application, or can provide a facility for performing runtime binding between operations in different applications.

Many applications include an application manifest that includes, among other things, the names of the particular intents supported by the application. Upon installation, the intents supported by the application are discovered by the operating system and associated with the application.

Thus, if an application has exposed all of its high-level operations as intents, an accessibility services or a virtual assistant can determine which events are available. However, even with such robust exposure of intents, multiple directions from the user may still be required to cause an application to perform a desired action. For example, for a calendar application, to change the time for a scheduled meeting, a user may be required to utter “Open calendar,” “Open meeting [identifying the specific meeting],” “Edit,” “Change time to [the desired time]” (e.g., 3:00 PM).

### SUMMARY

This specification describes technologies relating the operation of applications on a user device.

In general, one innovative aspect of the subject matter described in this specification can be embodied in methods that include the actions of accessing, for a first application, intent data describing intent groups for the first application, each intent group including one or more intents that belong to the intent group, and each intent described by intent descriptor data that specifies an action to be performed and data to be operated on by the action; determining enabling connectors for the intent groups, each enabling connector specifying an enabling intent that causes a corresponding intent group to become active in the first application and that belongs to an intent group that is different from the corresponding intent group that it causes to become active; generating intent group association data that associates intent groups to other intent groups by enabling connectors, wherein an enabling intent of an enabling connector that associates a first intent group to a second intent group belongs to the first intent group, and the second intent group becomes active in response to an execution of the enabling connector; and providing the intent group association data to a user device that has the first application installed. Other embodiments of this aspect include corresponding systems, apparatus, and computer programs, configured to perform the actions of the methods, encoded on computer storage devices.

In general, one innovative aspect of the subject matter described in this specification can be embodied in methods that include the actions of receiving, at the user device, association data that associates, for an application, intent groups to other intent groups by enabling connectors, wherein: an intent group includes one or more intents that belong to the intent group, and each intent is described by intent descriptor data that specifies an action to be performed and data to be operated on by the action; each enabling connector specifies an enabling intent that causes a corresponding intent group to become active in the application and that belongs to an intent group that is different from the corresponding intent group that it causes to become active; processing a command input by a user of the user device; determining that the command specifies an initiation of an intent for the application and for which the application is not in a state for which an intent group to which the intent belongs is enabled; in response to the determination: accessing the association data; determining a current location in the association data that corresponds to an intent group that is currently active for the application; determining a destination location in the association data that specifies the intent group to which the intent specified by the command belongs; traversing the association data from the current location to the destination location by one or more enabling connectors and, for each of the one or more enabling connectors, executing the enabling intent of the enabling connector as part of the traversal. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. A dynamic intent registry may enable a user device that has one or more application downloaded on the user device to use a multitude of the intents provided with the application(s) to navigate between intent groups in an easier and more fluid manner. This causes the user device to be able to navigate from an existing state in an application to a desired intent in the same application or a different application. Because the navigation involves the execution of possibly additional intents that are not uttered by the user, the user device can automatically identify and execute all predicate operations required for the desired operation. This causes the user device to operate in more efficient manner than would be realized by manual user inputs, including user selection inputs or low-level voice command inputs. Additionally, based on the dynamic intent registry, users are enabled to express what they want to do with respect to the user device, and the dynamic intent registry system provides the navigation to the expressed desired action of the user. Users are consequentially not required to develop a mental map of the device to know or remember the location of particular functionalities or the sequence of commands to arrive at the functionalities. Further, an additional advantage is that application developers can more easily make application functionality available as groups of intents, so it is feasible to cover all of the functionality of each of the applications. This advantage may be particularly important for users with disabilities, who might otherwise be unable to complete an action that is not initiated or covered by an intent. Thus, improvements to one or more technical fields, such as user interface and interaction models, application invocation, and parameter value specification, may be realized.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which applications are published.

FIG. 2 an illustration of intent information stored in intent registry for an example application.

FIG. 3 an illustration of an example intent group graph shown between multiple applications.

FIG. 4 between the assistant application at the user device, publishing application, and intent registry.

FIG. 5 is a flow diagram of an example process for generating and providing an intent graph structure to a user device.

FIG. 6 is a flow diagram of an example process 600 for using the intent graph structure to traverse between intent groups included in one or more application of the user device.

Like reference numbers and designations in the various drawings indicate like elements.

### DETAILED DESCRIPTION

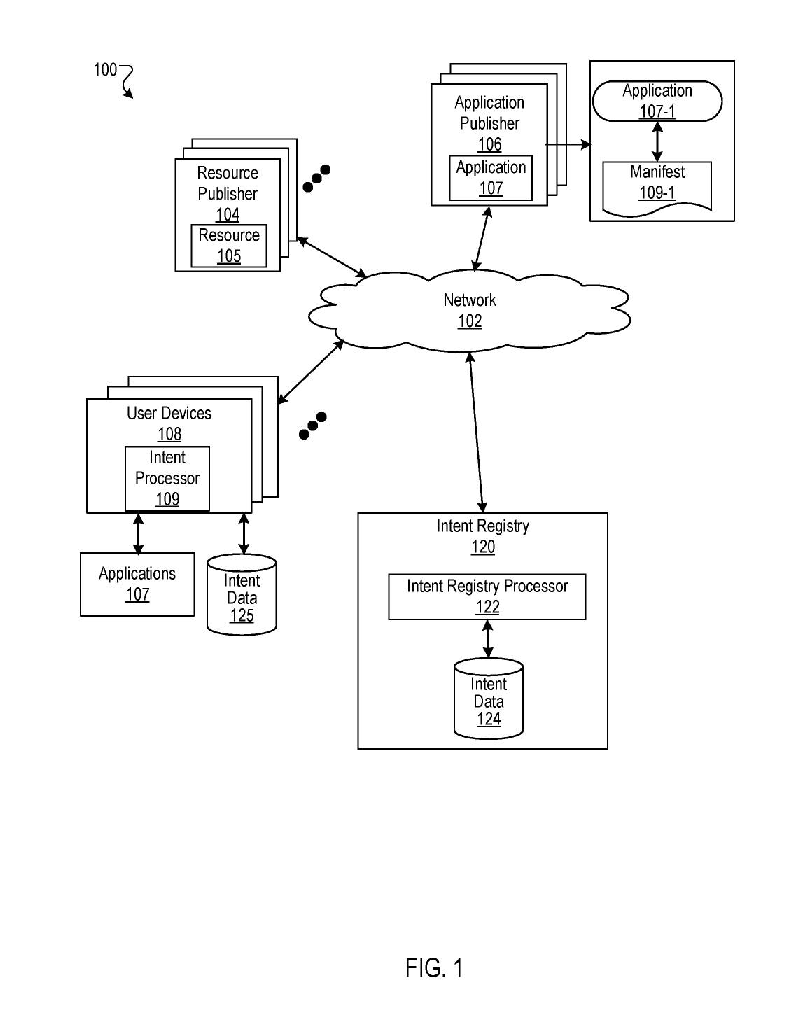

FIG. 1 is a block diagram of an example environment 100 in which applications 107 are published. A computer network 102, such as the Internet, connects resource publisher web sites 104, application publishers 106, user devices 108 and an intent registry 120.

A resource publisher website 104 includes one or more web resources 105 associated with a domain and hosted by one or more servers in one or more locations. Generally, a resource publisher web site is a collection of web pages formatted in hypertext markup language (HTML) that can contain text, images, multimedia content, and programming elements. Each website 104 is maintained by a content publisher, which is an entity that controls, manages and/or owns the website 104.

Some resource publishers 104 are application publisher 106 that provide applications 107. Applications 107 are designed to run on a particular user device operating system and machine firmware, and may operate independent of a browser application.

A user device 108 is an electronic device that is under the control of a user. A user device 108 is typically capable of requesting and receiving web page resources 104 and applications 107 over the network 102. Example user devices 108 include personal computers, mobile communication devices, and tablet computers.

An intent registry 120 may be included to provide user devices with intent data 124 that allows the user devices 108 a way to discover and execute different actions for one or more applications 107. Each application provided by a publisher 107 includes, for example, and application manifest file that describes operations of the application 107 and intents that may be supported and executed for those operations. The intent data 124 is a repository for descriptions intents for applications, and can be updated as application are likewise updated. Intent registry 120 may be implemented by an intent registry processor 122, and the intent registry processor 122 access intent data 124 to generate association data that links and associates intent groups to other intent groups for navigation between the intent groups, as will be described in more detail below. The intent registry processor 122 and intent data 124 are further described below.

Once updated, the intent data 124 can be distributed to user devices 108 upon which the application is installed. Thus, each user device 108, in some implementations, stores its own version of intent data 125. Applications and services may access the intent data 125 to discover operations of the applications as intents. The intents are organized into groups that correspond to different activities, and relationships between the groups are described in the data 124 and 125 to form a association of available operations. Using this association data, a user device 108 can determine a current state for a current application and determine what operations are necessary to perform a desired operation specified by a user.

However, by utilizing the intent data 125, the user device 108, executing an intent processor 109, allows services to find out about available intents, including those that may or may not be available directly from the current activity, and enables the services to navigate and execute sequences of intents that lead automatically to the desired intent requested by the user.

In the examples that follow, the systems and process are described in the context of an accessibility service executing on the user device 108. However, any application or service may make use of the features described below. For example, the intent processor 109 may be made available to services and applications by use of an API.

An application publisher 106 may provide to the intent registry 120 data that describes intent groups for an application. Such data may be in the form of an application manifest file, or any other data that describes intent groups and intents. An intent group includes one or more intents that belong to the intent group, and each intent specifies an action to be performed and data to be operated on by the action. Typically an intent group is a group of intents that are enabled when an application is in a particular state. For example, when a calendar application in a “view” state will have a first set of intents, such “Show [day|week|month],” “Open [event],” etc. Conversely, an “edit” state may have a second set of intents, such as “Set [time],” “Set [location],” and so on.

If data for an application 107 does not describe intents, then the intent registry 120 may develop, or otherwise create, data describing intents for those operations. For example, the intent registry processor 122 may instantiate a virtual machine that is that is programmed to explore application states and active intents for each state by means of an API. For example, a list view handler may make available application menus to the virtual machine, and the virtual machine may select each menu item to obtain additional menu items that become active in response to each selection.

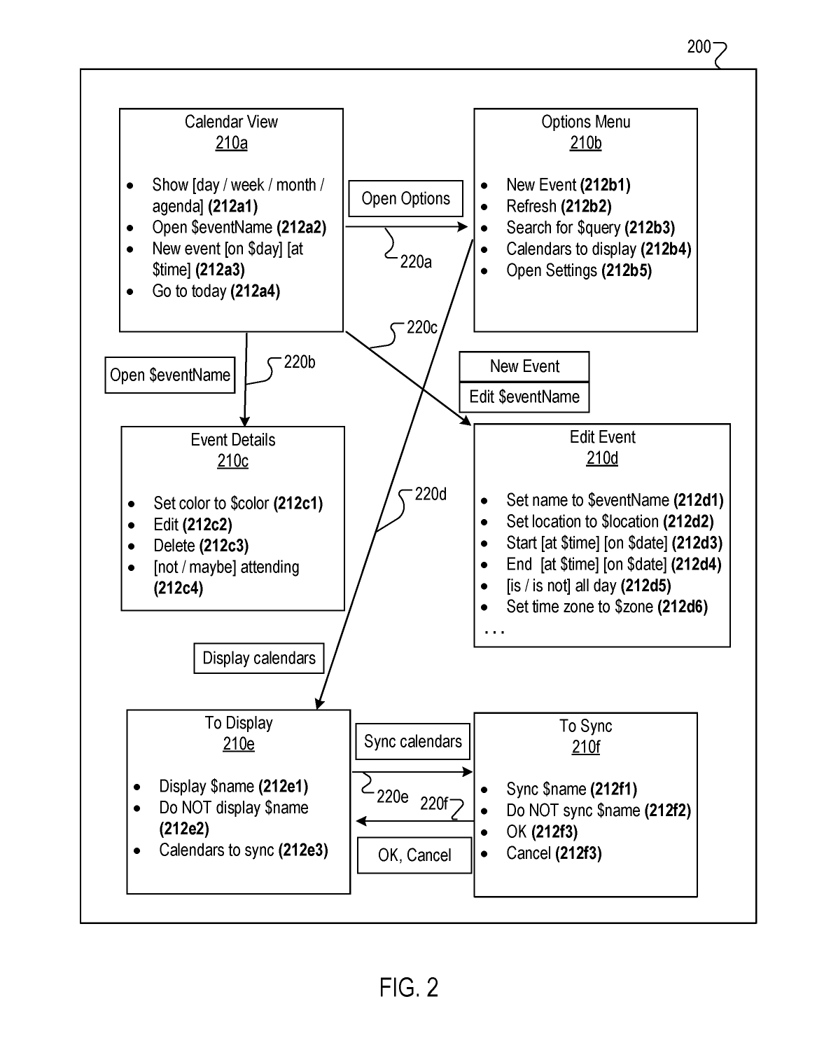

FIG. 2 is an illustration 200 of intent information 201 stored in intent registry 120 for an example application. The example application is a calendar application; however, intent information for other applications may be included in the intent registry. Each application may include a number of states that define the different activities that may be performed in the application and the display associated with each particular activity. In some implementations, only one state may be active at any point in time. In example application for FIG. 2, the calendar application includes a “Calendar View” state where the particular user's calendar may be viewed at the user device 108. Also, an “Options Menu” state is included for the user to create new events, search the user's calendar, or perform other options. A “To Display” state is included to display (or not display) a particular user's calendar. The “To Sync” state enables to user to sync their particular calendar with another user's calendar. “Event Details” state enables the user to select to edit, delete, or otherwise modify a particular event, and the “Edit” state enables the user to edit an event.

Each state of the application includes an intent group that identifies one or more of the intents that may be performed in that particular application state. For example, intent group 210a associated with the “Calendar View” state includes intents 212a1, 212a2, 212a3 and 212a4. Additionally, each intent is described by intent descriptor data that specifies an action to be performed associated with the particular intent and data to be operated on by the action. Additionally, the intent descriptor data may include one or more way to initiate its associated intent. For example, the intent descriptor data may include one or more name (either explicit or in the form of a parameter that may have several values), command, or unique identifier.

By way of example, intent 212a1 may provide for a day, week, month, or agenda view of the user's calendar. For example, the unique identifier or command for intent 212a1 may be a verbal command of “Show day” to display the day view, “Show week” to display the week view, “Show month” to display the month view, or “Show agenda” to display the particular user's agenda.

Additionally, one or more parameter types may also be provided with the intent descriptor data for its associated intent. For example, in the “Calendar View” state of example application 201, to open a particular event in the user's calendar, the user may initiate the “open” intent for a name or unique identifier for a particular event (e.g., identified by $eventName in FIG. 2). In some implementations, the event name may be recognized and identified by text and speech processing of the user device 108.

The intent group 210b associated with the “Options Menu” state includes, for example, intents 212b1, 212b2, 212b3, 212b4 and 212b5. Intent group 210c associated with the “Event Details” state includes, for example, intents 212c1, 212c2, 212c3 and 212c4. Intent group 210d associated with the “Edit Event” state includes, for example, intents 212d1, 212d2, 212d3, 212d4, 212d5 and 212d6. Intent group 210e associated with the “To Display” state includes, for example, intents 212e1, 212e2, and 212e3. Further, intent group 210f associated with the “To Sync” state includes, for example, intents 212f1, 212f2, 212f3, and 212f4. Each intent of the intent groups 210a, 210b, 210c, 210d, 210e, and 210f includes intent descriptor data that specifies an action to be performed and data to be operated on by the action and a unique identifier or command that may activate the intent group that includes the particular intent to be executed at the user device 108.

As illustrated in FIG. 2, each intent group in the application may include one or more enabling intents that initiates a particular type of intent that causes the application to activate a state in response to an operation performed by the enabling intent. Enabling intents cause another, different intent group to become enabled, as further described below. Like other intents, enabling intents include intent descriptor data that specifies an action to be performed and data to be operated on by the action along with a unique identifier or command to initiate the enabling intent. In the example application, enabling intent 220a may cause a transition the example application from the state of intent group 210a to the state of intent group 210b. For example, enabling intent 220a may be initiated, in some embodiments, by providing a verbal command of “Open Options,” when, in some implementations, example application 201 is in the state of intent group 210a.

Enabling intents for intent groups may be specified by an application publisher. An enabling intent serves to connect one intent group to another within an application, or connect an intent group for a first application to another intent group for another application. As used herein, when an enabling intent is performed that connects a first intent group to a second intent group, the enabling intent from the first intent group causes the second intent group to become enabled to be activated. An enabling intent may thus be modeled as a connector between intent groups. A publisher may specify enabling connectors for intent groups. Alternatively, the intent registry processor 122 may instantiate a virtual machine that is programmed to explore application states and active intents for each state by means of an API as described above.

In example application 201, enabling intent 220b may transition the example application from the state of intent group 210a to the state of intent group 210c. Likewise, enabling intent 220c and enabling intent 220d may transition the example application from the state of intent group 210a to the state of intent group 210d; enabling intent 220e may transition the example application 201 from the state of intent group 210b to the state of intent group 210e; enabling intent 220f may transition the example application 201 from the state of intent group 210e to the state of intent group 210f; and enabling intent 220g may transition the example application 201 from the state of intent group 210f to the state of intent group 210e.

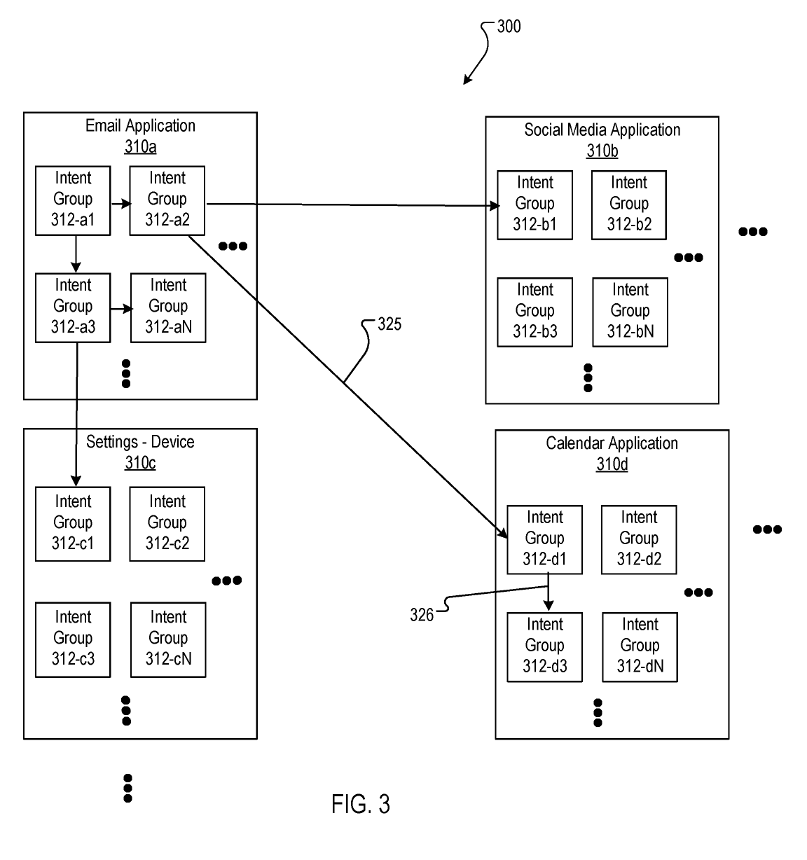

From the intent data, the intent registry processor 120 may generate data that associates s intent groups to other intent groups by enabling connectors. In some implementations, that association data may be in the form of a graph. FIG. 3 is an illustration of an example intent group graph 300 shown between multiple applications. The intent registry 120 may store the graph in the intent data 124. Intent group graph 300 includes four example applications 310a, 310b, 310c, and 310d, and the enabling connectors between intent groups of the same application or from an intent group of one application to an intent group of another application.

The intent data 124 may be provided to user devices 108 and stored locally as local intent data 125. The intent group graph 300 may include more applications than a particular user device 108 has installed. Alternatively, the user device 108 may receive or access the intent group graph 300 portion for the applications the user device 108 has downloaded on the device.

The intent group graph 300 may indicate each intent group (e.g., intent group 312-a1) as a graph node, and specify an enabling connector (e.g., 320a) as an edge between two graph nodes, for example, between intent group 312-a1 and intent group 312-a2. Although only one enabling connector is shown for each connection of two intent groups, two intent groups may be connected by two or more enabling connectors. In the intent group graph 300, the edges are unidirectional, where origin graph nodes represents the intent group to which the enabling intent belongs, and the destination graph node represents the intent group that would become active at the user device 108 when an operation corresponding to the enabling intent is executed.

As illustrated in the intent group graph 300, a user may have both example application 310a and 310d downloaded on their particular user device 108, and at a particular time, the user device 108 may have intent group 312-a2 active at the user device 108. For example, in the example application 310a, which may be an email application, intent group 312-a2 may be an intent group, such as “email view,” where a particular received email message is provided to the user of the user device 108. The email message may include, for example, a schedule and/or event name, and the user may wish to view calendar information in the example application 310d, the calendar application. Intent group 312-d1 may be, for example, the “calendar view” intent group. As seen in the example intent group graph 300, there is an enabling connector 325 between intent group 312-a2 and intent group 312-d1. The user may call (e.g., verbally commanding “calendar view”) or otherwise initiate that particular enabling connector for the user device 108 to use the intent group graph 300 and transition the active intent group and, in this case, application. After initiating the enabling connector 325, the intent group 312-d1 may be initiated at the user device 108.

In a further example, user device 108 may again have intent group 312-a2 active at the user device 108. However, in this case, the user of the user device 108 may wish to create a new calendar event in the example application 310d, the calendar application. Intent group 312-d3 may be the “new event” intent group. As seen in the example intent group graph 300, there is not an enabling connector between intent group 312-a2 and 312-d3. The intent processor 109 may determine the most efficient route of enabling connectors to traverse in order to reach intent group 312-d3 from the current active intent group 312-a2.

Efficiency may be based on the number of applications that will need to be accessed and opened, the amount of memory required, and the number of enabling connectors to be initiated and traversed, and other appropriate factors. In the current example, from the current active intent group 312-a2, the user device 108 may initiate enabling connector 325 to reach intent group 312-d1 and then enabling connector 326 to transition from intent group 312-d1 to intent group 312-d3. Enabling connector 326 may not be initiated directly from intent group 312-a2, but may be initiated from intent group 312-d1. In some implementations, the initiation of intermediate intent groups (e.g., as intent group 312-d1 in the current example) may or may not be shown at the user device 108.

For example, suppose the user is viewing an e-mail from an associate, Jane Doe, and the intent group 312-a2 is active. The user may want to schedule a meeting with Jane, and thus the user utters, “Show me sender's calendar.” The enabling connector 325 may be an intent that initiates a “To Display” intent group of a calendar application, which corresponds to intent group 312-d1 of the calendar application 310d. With the intent group 312-d1, there may be an intent “Show $Contact Calendar”, where $Contact is a contact name. Here, the user specified “Sender,” which is resolved to Jane Doe, the sender of the e-mail message. This is passed as a parameter value to an operation invoked by an intent group 312-d1, e.g., “Show Jane Doe Calendar,” which instantiates a “Calendar View” intent group 312-d3, and result in the operation of displaying Jane Doe's calendar. If the parameter value is missing, the user device 108 may be caused to prompt the user for the value.

Thus, by traversing the association data, the intent processor 109 eliminates the need for the user to specify each intermediate operation required to transition from a current state in an active application to another state in the active application or another, different application.

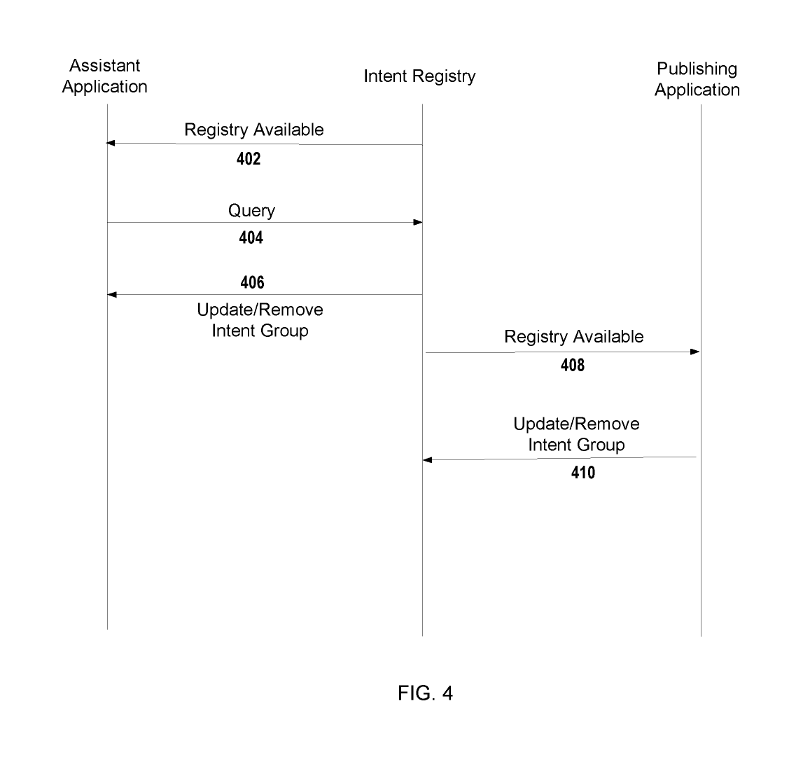

The intent registry allows publishers to dynamically update intent data, and provides updated intent data to user devices. FIG. 4 is an example data exchange between the assistant application at the user device 108, publishing application, and intent registry. As previously described, the assistant application is used to execute different actions (e.g., intents) for one or more application. The intent registry 120 receives intent information, as described in FIGS. 2 and 3, from publishing applications (e.g., calendar application and the other applications seen in FIG. 3), and generates association data that enable the assistant application to transition from active intent groups to other intent groups. As illustrated in FIG. 4, the intent registry 120 may notify the assistant application that the intent registry is available (402) to access. The assistant application may query the intent registry 120 (404) to obtain contents of the intent registry 120. The intent registry 120 may then provide updates of intent groups of publishing applications or remove intent groups of publishing applications (406). The content of the intent registry 120 may be for intents of publishing applications that are both included in the intent registry 120 and on the user device 108 using the assistant application.

Additionally, the intent registry 120 may notify one or more publishing application that the intent registry is available (408). The publishing application may then provide intent groups for the applications published by the publisher, or the publishing application may specify updates and/or removal of intent groups for the intent registry 120 association data (410). The updates and/or removal of intent groups may then be provided to the assistant application, as seen in 406 of FIG. 4.

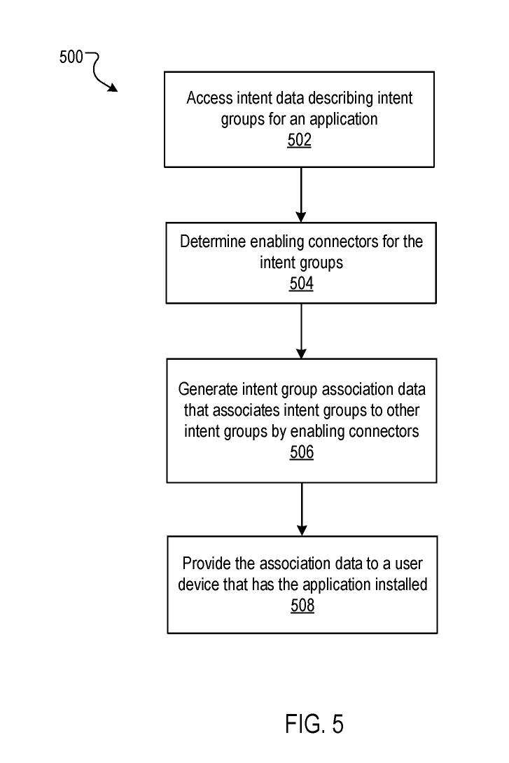

FIG. 5 is a flow diagram of an example process 500 for generating and providing an intent graph structure to a user device. The process 500 can, for example, be implemented by the intent registry 120. In some implementations, the operations of the example process 500 can be implemented as instructions stored on a non-transitory computer readable medium, where the instructions cause a data processing apparatus to perform operations of the example process 500.

Intent data is accessed that describes intent groups for an application (502). Each intent group including one or more intents that belong to the intent group. Each intent group identifies one or more of the intents that may be performed in that particular application state. Also, each intent is described by intent descriptor data that specifies an action to be performed and data to be operated on by the action. The intent descriptor data may include one or more name, command, or unique identifier that may be input at the user device 108 to call or initiate the particular intent, a human readable name for the intent that may be identified by the assistance application or other software component of the user device 108, or other way of selecting the particular intent. For example, when a particular unique identifier for an intent is provided to the user device 108, the application state for the intent group that included the particular intent may be initiated to execute the particular intent

Enabling connectors for the intent groups are determined (504). Each enabling connector specifies an enabling intent that causes a corresponding intent group to become active in the application. Enabling intents also include intent descriptor data that specifies an action to be performed and data to be operated on by the action along with a unique identifier or command to initiate the enabling intent. Also, each enabling intent belongs to an intent group that is different from the corresponding intent group that it causes to become active. The enabling connectors may extend between intent groups of the same application or from an intent group of one application to an intent group of another application.

Intent group association data that provides navigation for intent groups to other intent groups by enabling connectors is generated (506). In some implementations, the association data may be in the form of a graph structure that specifies each intent group as a graph node and each enabling connector as an edge between two graph nodes. By way of example, as seen in FIG. 3, the intent group graph may indicate each intent group (e.g., intent group 312-a1) as a graph node, and specify an enabling connector (e.g., 320a) as edge between two graph nodes, for example, between intent group 312-a1 and intent group 312-a2. In the intent group graph 300, the first of the two graph nodes may the intent group to which the enabling intent belongs and the intent group that would be active at the user device 108 for its associated enabling connector(s) to be used. The second of the two graph nodes (e.g., intent group 312-a2) is the intent group that becomes actives in response to the execution of the enabling connector (e.g., 320). The navigation data is then be provided to a user device that has the application installed (508).

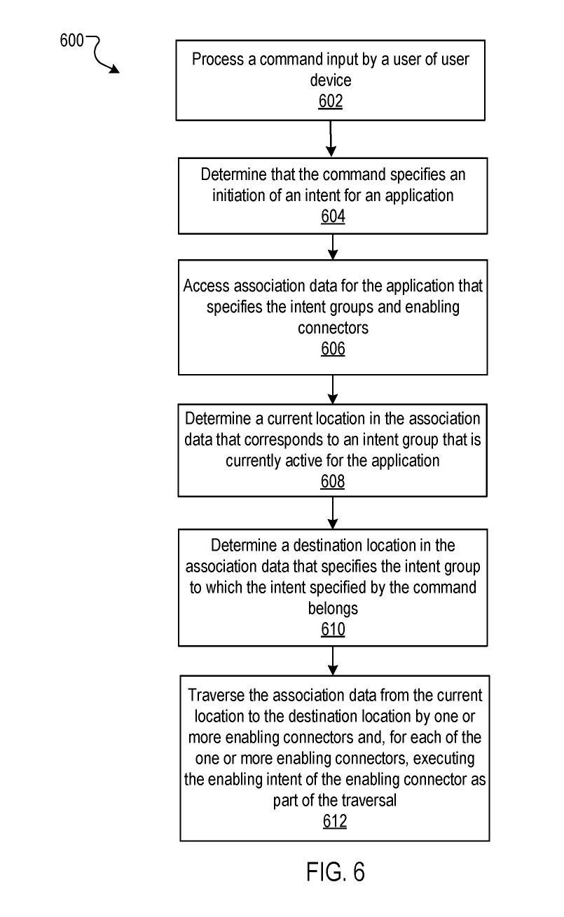

FIG. 6 is a flow diagram of an example process 600 for using the intent graph structure to traverse between intent groups included in one or more application of the user device 108. The process 600 can, for example, be implemented by a user device 108 and/or the assistant application. In some implementations, the operations of the example process 600 can be implemented as instructions stored on a non-transitory computer readable medium, where the instructions cause a data processing apparatus to perform operations of the example process 600.

A command input by a user of the user device is processed (602). A command input may be any type of selection or input provided at the user device 108. For example, the command input may be selection of an item on the user device 108 (e.g., button or interface), auditory command, or textual input command, among others.

A determination may be made that the command specifies an initiation of an intent for an application and for which the application is not in a state for which an intent group to which the intent belongs is enabled (604). As previously described, each intent group includes one or more intents that belong to the intent group. Each intent group identifies one or more of the intents that may be performed in that particular application state. Also, each intent is described by intent descriptor data that specifies an action to be performed and data to be operated on by the action. The intent descriptor data may include one or more name, command, or unique identifier that may be input at the user device 108 to call or initiate the particular intent, a human readable name for the intent that may be identified by the assistance application or other software component of the user device 108, or other way of selecting the particular intent. For example, based on the example provided in FIG. 2, the user may be in the calendar view state (intent group 210a), and the user may provide a command, for example, by speaking “sync Charlie,” (e.g., where “Charlie” is listed as a contact and calendar privileges are shared between the user and “Charlie”) to the user device 108. A determination may be made by the assistant application at the user device 108 that the command specifies an initiation of the intent 212f1 in the intent group 210f, and the user device 108 associated with the application is not in the intent group 210f state.

Association data for the application that specifies the intent groups and enabling connectors is accessed (606). For example, in the case of a graph structure, an intent group graph structure for the application that specifies each intent group for the application as a graph node, and an enabling connector as an edge between two graph nodes is accessed (606). A first of the two graph nodes may be determined, which is the intent group to which the enabling intent belongs, and the second of the two graph nodes may be determined, which is the intent group that becomes actives in response to the execution of the enabling connector. As previously described, enabling connectors may extend between intent groups of the same application or from an intent group of one application to an intent group of another application.

A current location in the association data that corresponds to an intent group that is currently active for the application is determined (608). For example, a current node in the intent graph structure for the application is determined. Based on the example above, when the user of the user device 108 is in the calendar view state of the application 201, the intent graph structure may indicate that the current node is the intent group 210a of the example application 201.

A destination location in the association data that specifies the intent group to which the intent specified by the command belongs is determined (610). For example, a target node in the intent graph structures that specifies the intent group to which the intent specified by the command belongs is determined. Based on the example above and FIG. 2, the intent graph structure may indicate that the target node is the intent group 210f of the example application 201.

The system traverses the association data from the current location to the destination location by one or more enabling connectors and, for each of the one or more enabling connectors, executes the enabling intent of the enabling connector as part of the traversal (612). Continuing with the graph data example, a traversal of the intent graph structure from the current node to the target node is then performed, and for each edge in traversal, the enabling connector is executed in an order according to the traversal from the current node to the target node. Based on the example above and FIG. 2 and its description, when the current node is intent group 210a and the target node is intent group 210f, the enabling connector 220a is to be executed for intent group 210b to be activated, which may then execute enabling connector 220d to activate intent group 210e, which may then finally execute enabling connector 220e for intent group 210f, the target node, to be activated. Although this example is described as the intent graph structure being within one application, more applications may be included in the intent graph structure, as described above. Additionally, in some implementations, there may be more than one path to reach a target node from a current node, and in such cases different factors may be used to determine the path to use. For example, the factors may include one or more of the shortest path, the path that uses the least amount of processing power from the user device 108, the first way determined, among others.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a user computer having a graphical display or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
accessing, for a first application, intent data describing intent groups for the first application, each intent group including one or more intents that belong to the intent group, and each intent described by intent descriptor data that specifies an action to be performed and data to be operated on by the action;
determining enabling connectors for the intent groups, each enabling connector specifying an enabling intent that causes a corresponding intent group to become active in the first application and that belongs to an intent group that is different from the corresponding intent group that it causes to become active;
generating intent group association data that associates intent groups to other intent groups by enabling connectors, wherein an enabling intent of an enabling connector that associates a first intent group to a second intent group belongs to the first intent group, and the second intent group becomes active in response to an execution of the enabling connector; and
providing the intent group association data to a user device that has the first application installed.

2. The computer-implemented method, wherein generating intent group association data comprises generating an intent group graph structure that specifies each intent group as a graph node, and that specifies an enabling connector as an edge between two graph nodes, wherein the first of the two graph nodes is the first intent group to which the enabling intent belongs, and the second of the two graph nodes is the second intent group that becomes actives in response to the execution of the enabling connector.

3. The computer-implemented method of claim 2, further comprising:
accessing, for a second application, intent data describing intent groups for the second application, each intent group including one or more intents that belong to the intent group, and each intent described by intent descriptor data that specifies an action to be performed and data to be operated on by the action; and
determining enabling connectors for the intent groups, each enabling connector specifying an enabling intent that causes a corresponding intent group to become active in the second application, and that belongs to an intent group that is different from the corresponding intent group that it causes to become active, the determining enabling connectors including determining at least one enabling connector that belongs to an intent group of the first application and that causes an intent group to become active in the second application.

4. The computer-implemented method of claim 2, wherein:
the first intent group in a view intent group that is active when the first application is in a state that includes a first set of intents;
the second intent group is an intent group that is active when the first application is in a state that includes a second set of intents; and
wherein the enabling connector that connects a graph node specifying the first intent group to a graph node specifying the second intent group specifies one of the intents of the first set of intents as the enabling intent.

5. The computer-implemented method of claim 4, wherein:
at least one enabling intent specifies a parameter; and
the group association data causes a user device to generate a prompt for a parameter value in response to an invocation of the enabling intent without a parameter value.

6. The computer-implemented method of claim 1, further comprising:
accessing, for a second application, intent data describing intent groups for the second application, each intent group including one or more intents that belong to the intent group, and each intent described by intent descriptor data that specifies an action to be performed and data to be operated on by the action; and
determining enabling connectors for the intent groups, each enabling connector specifying an enabling intent that causes a corresponding intent group to become active in the second application, and that belongs to an intent group that is different from the corresponding intent group that it causes to become active, the determining enabling connectors including determining at least one enabling connector that belongs to an intent group of the first application and that causes an intent group to become active in the second application.

7. The computer-implemented method of claim 5, wherein:
the first intent group in a view intent group that is active when the first application is in a state that includes a first set of intents;
the second intent group is an intent group that is active when the first application is in a state that includes a second set of intents; and
wherein the enabling connector that connects a graph node specifying the first intent group to a graph node specifying the second intent group specifies one of the intents of the first set of intents as the enabling intent.

8. A computer-implemented method executed at a user device, comprising:
receiving, at the user device, association data that associates, for an application, intent groups to other intent groups by enabling connectors, wherein:
an intent group includes one or more intents that belong to the intent group, and each intent is described by intent descriptor data that specifies an action to be performed and data to be operated on by the action;
each enabling connector specifies an enabling intent that causes a corresponding intent group to become active in the application and that belongs to an intent group that is different from the corresponding intent group that it causes to become active;
processing a command input by a user of the user device;
determining that the command specifies an initiation of an intent for the application and for which the application is not in a state for which an intent group to which the intent belongs is enabled;
in response to the determination:
accessing the association data;
determining a current location in the association data that corresponds to an intent group that is currently active for the application;
determining a destination location in the association data that specifies the intent group to which the intent specified by the command belongs;
traversing the association data from the current location to the destination location by one or more enabling connectors and, for each of the one or more enabling connectors, executing the enabling intent of the enabling connector as part of the traversal.

9. The computer-implemented method of claim 8, wherein:
the association data comprises an intent group graph structure that specifies each intent group as a graph node, and that specifies each enabling connector as an edge between two graph nodes, wherein the first of the two graph nodes is the first intent group to which the enabling intent belongs, and the second of the two graph nodes is the second intent group that becomes actives in response to the execution of the enabling connector.

10. The computer-implemented method of claim 9, wherein:
determining a current location in the association data that corresponds to an intent group that is currently active for the application comprises determining a current node that corresponds to the intent group that is currently active for the application
determining a destination location in the association data that specifies the intent group to which the intent specified by the command belongs comprises determining a target node that corresponds to the intent group to which the intent specified by the command belongs;
traversing the association data from the current location to the destination location by one or more enabling connectors comprises traversing the graph from the current node to the target by use of the edges; and
for each of the one or more enabling connectors, executing the enabling intent of the enabling connector as part of the traversal comprises, for each edge in traversal, executing the enabling intent.

11. The computer-implemented method of claim 10, wherein:
at least one enabling intent specifies a parameter; and
the group association data causes a user device to generate a prompt for a parameter value in response to an invocation of an enabling intent without a parameter value.

12. The computer-implemented method of claim 8, wherein:
at least one enabling intent specifies a parameter; and
the group association data causes a user device to generate a prompt for a parameter value in response to an invocation of an enabling intent without a parameter value.

13. The computer-implemented method of claim 8, wherein:
at least one enabling connector specifies an enabling intent for an intent that causes a corresponding intent group to become active in a second application and links to the corresponding intent group in the second application from an intent group in a first application.

14. The computer-implemented method of claim 8, further comprising:
determining there is more than one path for the traversal from the current location to the destination location;
for each path, determining a number of enabling connectors required to be executed in the traversal from the current location to the destination location; and
traversing the association data from the current location to the destination location based on the path that executes the lowest number of enabling connectors in the traversal from the current location to the destination location.

15. A system, comprising:
a data processing apparatus; and
software stored in non-transitory computer readable storage medium storing instructions executable by the data processing apparatus and that upon such execution cause the data processing apparatus to perform operations comprising:
accessing, for a first application, intent data describing intent groups for the first application, each intent group including one or more intents that belong to the intent group, and each intent described by intent descriptor data that specifies an action to be performed and data to be operated on by the action;
determining enabling connectors for the intent groups, each enabling connector specifying an enabling intent that causes a corresponding intent group to become active in the first application and that belongs to an intent group that is different from the corresponding intent group that it causes to become active;
generating intent group association data that associates intent groups to other intent groups by enabling connectors, wherein an enabling intent of an enabling connector that associates a first intent group to a second intent group belongs to the first intent group, and the second intent group becomes active in response to an execution of the enabling connector; and
providing the intent group association data to a user device that has the first application installed.

16. A computer-readable medium having instructions stored thereon, which, when executed by a processor, cause the processor to perform operations, comprising:
accessing, for a first application, intent data describing intent groups for the first application, each intent group including one or more intents that belong to the intent group, and each intent described by intent descriptor data that specifies an action to be performed and data to be operated on by the action;
determining enabling connectors for the intent groups, each enabling connector specifying an enabling intent that causes a corresponding intent group to become active in the first application and that belongs to an intent group that is different from the corresponding intent group that it causes to become active;
generating intent group association data that associates intent groups to other intent groups by enabling connectors, wherein an enabling intent of an enabling connector that associates a first intent group to a second intent group belongs to the first intent group, and the second intent group becomes active in response to an execution of the enabling connector; and
providing the intent group association data to a user device that has the first application installed.
